(19) United States
(12) Patent Application Publication
(10) Pub. No.: US 2007/0189554 A1
(43) Pub. Date: Aug. 16, 2007

(54) Audio speaker including impedance matching circuit

(76) Inventors: David S Innis, Redwood City, CA (US); Joseph Mark Wright, Cupertino, CA (US)

Correspondence Address: INTELLECTUAL PROPERTY LAW OFFICES, 1901 S. BASCOM AVENUE, SUITE 660, CAMPBELL, CA, 95008, US

(21) Appl. No.: 10/585,897

(22) PCT Filed: Jan. 12, 2005
(86) PCT No.: PCT/US05/01019

§ 371 Date: Jul. 11, 2006

Related U.S. Application Data
(60) Provisional application No. 60/536,753, filed on Jan. 13, 2004.

(51) Int. Cl. H04R 3/00

(52) U.S. Cl. 381/111; 381/116

(57) ABSTRACT

An audio speaker (10) including an electrical circuit that is interconnected within the speaker circuitry within the speaker enclosure (14) to selectively alter the resistance of the speaker (10), such as from 4 ohms to 8 ohms. It therefore allows the owner to use the speaker as a replacement speaker for both 4 ohm and 8 ohm amplifiers. It also allows the owner to engage additional speakers to an amplifier (58) without causing damage to the amplifier (58). In a preferred embodiment, the speaker includes two drivers (18/22) that are electrically engaged in parallel in the speaker circuit, wherein a plurality of capacitors (44) are engaged in parallel within the speaker circuit, and an electrical switch is engaged to selectively shunt electrical current around said plurality of capacitors (44) to alter the resistance of the speaker.

### CROSS-REFERENCED TO RELATED APPLICATION

This application claims priority to U.S. Provisional Patent Application Ser. No. 60/536,753, filed Jan. 13, 2004, entitled: Audio Speaker Impedance Matching Circuit.

### BACKGROUND OF THE INVENTION

1. Field of the Invention

The present invention relates generally to audio speakers and speaker circuits, and more particularly to such speaker circuits having a user operable impedance altering circuit therewithin.

2. Description of the Prior Art

In audio systems including an amplifier and a plurality of speakers, the amplifier output circuit is typically designed to be connected to speaker systems having a resistance such as 8 ohms or 4 ohms, and the speakers are therefore designed to have a matching resistance such as 8 ohms or 4 ohms. The owners of such audio systems often have a desire to change speakers and/or to add more speakers onto the amplifier in order to obtain an improved sound quality.

When changing speakers for an existing amplifier, the replacement speakers must have the same resistance as the prior speakers to match the amplifier output circuit.

The process of adding additional speakers to an existing system is typically attempted by adding a new speaker in parallel with the existing speaker. However, as is well known, the total resistance of the two speakers in parallel will be less than, typically approximately half of, the resistance of one of the speakers. That is, two 8 ohm speakers when connected in parallel will have a total resistance of approximately 4 ohms. Where a cumulative resistance of 4 ohms from the two parallel speakers is engaged to the 8 ohm speaker output of an amplifier it can cause overheating and damage to the amplifier output circuit.

### SUMMARY OF THE INVENTION

The present invention is a speaker including an electrical circuit that is interconnected within the speaker circuitry within the speaker enclosure to selectively alter the resistance of the speaker, such as from 4 ohms to 8 ohms. It therefore allows the owner to use the speaker as a replacement speaker for both 4 ohm and 8 ohm amplifiers. It also allows the owner to engage additional speakers to an amplifier without causing damage to the amplifier. In a preferred embodiment, the speaker includes two drivers that are electrically engaged in parallel in the speaker circuit, wherein a plurality of capacitors are engaged in parallel within the speaker circuit and an electrical switch is engaged to selectively shunt electrical current around said plurality of capacitors to alter the resistance of the speaker.

It is an advantage of the audio speaker impedance matching circuit of the present invention that it provides a speaker with user selectable resistance.

It is another advantage of the audio speaker impedance matching circuit of the present invention that it provides speakers with a plurality of drivers therewithin, and a user selectable resistance of the speaker.

It is a further advantage of the audio speaker impedance matching circuit of the present invention that it includes a speaker with two drivers and an electrical circuit that includes a user operable switch for altering the resistance of the speaker driver circuit.

It is yet another advantage of the audio speaker impedance matching circuit of the present invention that it provides a speaker with user selectable resistance, such that additional speakers may be added to an amplifier circuit without overloading the amplifier.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 is a schematic diagram of a speaker including two drivers and the impedance matching circuit of the present invention.

FIG. 2 is a schematic diagram of an amplifier with two speakers engaged in a parallel circuit configuration.

### DETAILED DESCRIPTION OF THE PREFERRED EMBODIMENTS

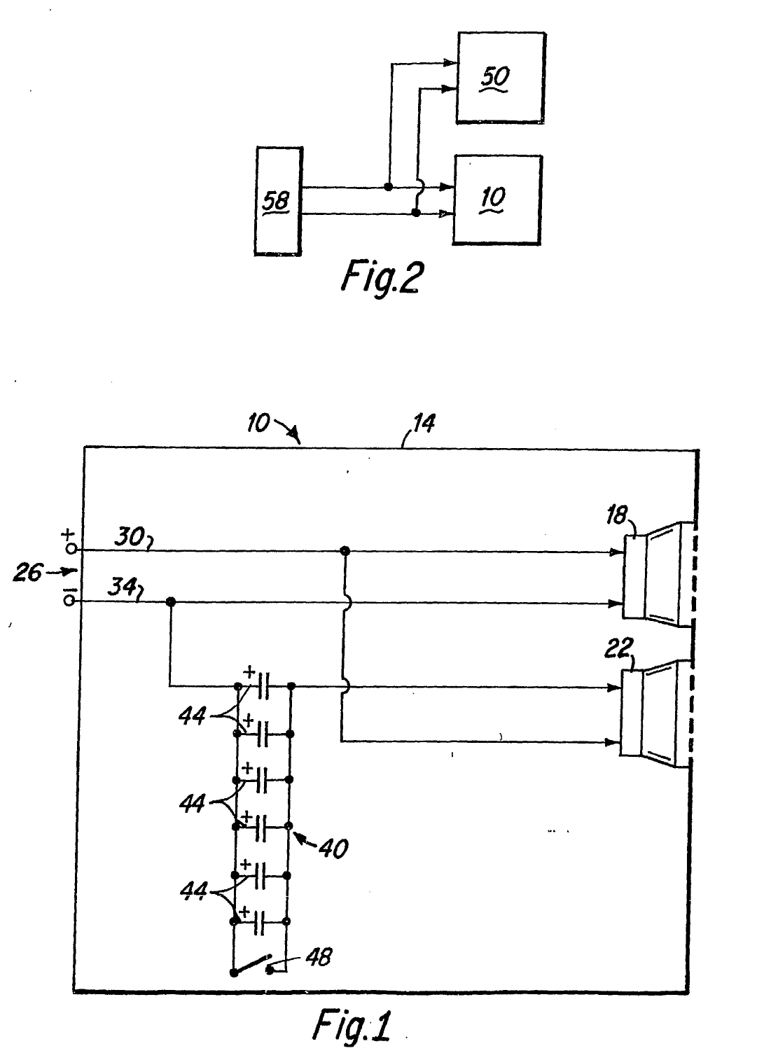

As depicted in FIG. 1, a speaker 10 includes a speaker enclosure 14 having two drivers 18 and 22 disposed within the enclosure 14. An audio signal input jack 26 at the rear of the speaker enclosure includes a positive lead 30 and a negative lead 34. Driver 18 is directly connected to the two leads 30 and 34. Driver 22 is connected in parallel with driver 18. Significantly, the impedance matching circuit 40 of the present invention is connected to one of the two leads to driver 22; in this instance it is connected to the negative lead 34 connection to driver 22.

The impedance matching circuit 40, as shown in FIG. 1, includes a plurality of capacitors 44, preferably electrolytic capacitors, that are engaged in parallel. A bypass switch 48 is engaged across the capacitors, and in the preferred embodiment, the bypass switch 48 will be located at the rear exterior of the speaker enclosure for access by the user of the speaker.

An example of the use of the present invention is as follows. Initially, assume that each of the drivers 18 and 22 is an 8 ohm driver, and assume that the bypass switch 48 is closed, such that the capacitors 44 are bypassed and essentially not part of the electrical circuitry. The total resistance of the speaker 10 with its two 8 ohm drivers connected in parallel will be 4 ohms. This speaker 10 is designed to be connected to an amplifier having a 4 ohm audio output for connection with a speaker. Significantly, the speaker 10 is designed to also be connected to an amplifier having an 8 ohm audio output for connection with a speaker. Specifically, where the bypass switch 48 is opened, the DC resistance of the second driver 22 is greatly increased because the capacitors now act as an open circuit in the lead to driver 22. Therefore, when the bypass switch 48 is open, the DC resistance at the speaker input 26 is only the resistance of the first driver 18, which is 8 ohms, and it can be connected to an 8 ohm amplifier speaker outlet.

By way of a further example, if the two drivers 18 and 22 have a 16 ohms resistance, the impedance matching circuit 40 would give the user a choice of an 8 ohm speaker resistance when the bypass switch is closed or a 16 ohm resistance when the bypass switch is open.

The speaker 10 is also suitable for engagement as an additional speaker in a parallel circuit configuration. Specifically, with reference to FIG. 2, assume that the user of the audio system desires to engage a second speaker 50 that is identical to speaker 10 to an amplifier 58 using the amplifier's 4 ohm speaker outlet. The user accomplishes this by attaching the second speaker 50 in parallel with the first speaker 10 to the amplifier 58 as is depicted in FIG. 2. Where prior art speakers that lack the impedance matching circuit of the present invention are engaged as depicted in FIG. 2, the parallel connection of the two 4 ohm speakers will create a total speaker impedance to the amplifier of approximately 2 ohms, which input impedance is so low as to probably damage the amplifier. However, where the two speakers 10 and 50 that are connected in parallel include the impedance matching circuit 40 of the present invention, the overall impedance of the speaker circuit can be properly modified.

Specifically, returning to FIG. 1, where the bypass switch 48 is opened, the DC resistance of the second driver 22 is greatly increased because the capacitors now act as an open circuit in the lead to driver 22, and the DC resistance at the speaker input 26 is only the resistance of the first driver 18, which is 8 ohms. Thus, by opening the bypass switch 48, the impedance of the speaker 10 is altered from 4 ohms to 8 ohms. Therefore, returning to FIG. 2, where each of the speakers 10 and 50 includes the impedance matching circuit 40 of the present invention, the bypass switch 48 of each speaker 10 and 50 is opened, such that the DC resistance of each speaker becomes 8 ohms, and the total resistance of the two 8 ohm speakers 10 and 50 engaged in parallel becomes 4 ohms, which matches the impedance of the speaker outlet of the amplifier 58. Thus the use of the impedance matching circuit 40 of the present invention allows the user to engage additional speakers in parallel without the threat of damage to the amplifier.

By way of a further example, when the two speakers 10 and 50 include 16 ohm drivers, the total resistance of the two speakers 10 and 50 in parallel will be 4 ohms when the bypass switch of each circuit 40 of each speaker 10 and 50 is closed, and the total resistance of the two speakers 10 and 50 in parallel will be 8 ohms when the bypass switch of the circuit 40 of each speaker 10 and 50 is open.

Returning to FIG. 1, it is seen that the impedance matching circuit 40 of the present invention includes 6 capacitors 44. However, the present invention is not to be so limited, and may include an impedance matching circuit having one, two, three, four, five, six or more capacitors. However, an impedance matching circuit having a plurality of capacitors, such as 6, is preferred over an impedance matching circuit having one or even two capacitors. This is because the capacitance of the impedance matching circuit is desirably chosen to be large enough that the impedance circuit does not act as a high pass filter circuit. That is, it is desired that all of the amplifier's audio signal, even down to as low as 2 Hz, be transmitted to the driver 22. To accomplish this, a total capacitance of approximately 1,200 microfarads is desired for the impedance matching circuit for an 8 ohm driver. A single capacitor having a 1,200 microfarad capacitance will generally be quite large, whereas a plurality of capacitors (as shown), connected in parallel is considerably smaller and is easily mounted upon a printed circuit board for installation within the speaker cabinet 14. A second reason for the utilization of a plurality of capacitors 44 is that each capacitor will generally have a certain resistance, termed its equivalent series resistance. It is desirable to minimize this resistance as it will affect the quality of sound from the driver 22. Where a plurality of capacitors, each having an equivalent series resistance is connected in parallel (as shown in FIG. 1), the overall total resistance of the circuit is reduced to insignificance. In the preferred embodiment, 6 capacitors are engaged in parallel with an 8 ohm driver, as shown, where each capacitor has a capacitance of approximately 220 microfarads, where each capacitor is an electrolytic capacitor that is rated at 150 volts. If the driver were a 4 ohm driver then the six capacitors would preferably be approximately 440 microfarads each, and if the driver were a 16 ohm driver the six capacitors would be approximately 110 microfarads each.

The capacitance in this circuit is set so high that it will pass all audio frequencies of interest. It is not designed to block any audio signals such that the driver 22 receives the full range of signal from the amplifier. The capacitance is selected to pass all frequencies above a low point which is set at approximately 2 Hz, such that all of the audio sound above 2 Hz is passed to the driver 22. Additionally, the audio feed to the first driver 18 is not affected because it does not have the impedance matching circuit in it, so the first driver receives the full audio signal from the amplifier.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

What I claim is:

1. An audio speaker, comprising:
a speaker enclosure;
at least two drivers being disposed within said enclosure;
a speaker circuit, including:
a first electrical lead being engaged to a first said driver;
a second electrical lead being engaged to said first driver;
said first electrical lead being engaged to a second said driver;
said second electrical lead including an impedance circuit and being engaged to said second driver;
said impedance circuit including a plurality of capacitors being engaged in parallel and an electrical switch being engaged to shunt electrical current around said plurality of capacitors.

2. An audio speaker as described in claim 1 wherein said electrical switch is connected in parallel with said capacitors.

3. An audio speaker as described in claim 1 wherein said first driver and said second driver are connected in parallel within said speaker circuit.

4. An audio speaker as described in claim 2 wherein each capacitor has approximately the same capacitance.

5. An audio speaker as described in claim 1 wherein each said driver has a resistance, and wherein when said electrical switch is closed the total resistance of the speaker circuit is reduced.

6. An audio speaker as described in claim 1 wherein when said electrical switch is open electrical current flows through said capacitors.

7. An audio speaker as described in claim 1 wherein when said electrical switch is closed electrical current flows through said switch and not through said capacitors.

8. An audio speaker as described in claim 1 wherein said speaker enclosure includes two substantially identical drivers, and wherein the resistance of said speaker circuit is reduced approximately by half when said electrical switch is closed.

9. An audio speaker as described in claim 1 wherein said speaker circuit has a resistance of approximately 4 ohms when said electrical switch is closed and approximately 8 ohms when said electrical switch is opened.

10. An audio speaker as described in claim 1 wherein said speaker circuit has a resistance of approximately 8 ohms when said electrical switch is closed and approximately 16 ohms when said electrical switch is opened.

11. An audio speaker, comprising:
a speaker enclosure;
at least two audio drivers being disposed within said enclosure;
each said driver being engaged in a speaker circuit with two electrical signal wires, such that said drivers are electrically connected in a parallel circuit configuration within said enclosure;
said speaker circuit including a plurality of capacitors and an electrical switch being operable to electrically bypass said plurality of capacitors.

12. An audio speaker as described in claim 11 wherein said electrical switch is connected in parallel with said capacitors.

13. An audio speaker as described in claim 12 wherein said capacitors are connected in parallel within said speaker circuit.

14. An audio speaker as described in claim 11 wherein each capacitor has approximately the same capacitance.

15. An audio speaker as described in claim 11 wherein each said driver has a resistance, and wherein when said electrical switch is closed the total resistance of the speaker circuit is reduced.

16. An audio speaker as described in claim 12 wherein when said electrical switch is open electrical current flows through said capacitors.

17. An audio speaker as described in claim 12 wherein when said electrical switch is closed electrical current flows through said switch and not through said capacitors.

18. An audio speaker as described in claim 11 wherein said speaker enclosure includes two substantially identical drivers, and wherein the resistance of said speaker circuit is reduced approximately by half when said electrical switch is closed.

19. An audio speaker as described in claim 11 wherein said speaker circuit has a resistance of approximately 4 ohms when said electrical switch is closed and approximately 8 ohms when said electrical switch is opened.

20. An audio speaker as described in claim 11 wherein said speaker circuit has a resistance of approximately 8 ohms when said electrical switch is closed and approximately 16 ohms when said electrical switch is opened.
